(19) United States
(12) Patent Application Publication
(10) Pub. No.: US 2026/0235174 A1
(43) Pub. Date: Aug. 13, 2026

(54) BRAKE PAD LINER AND BRAKE ASSEMBLY COMPRISING THE SAME

(71) Applicant: HL MANDO CORPORATION, Pyeongtaek-si (KR)

(72) Inventor: Sungho JIN, Pyeongtaek-si (KR)

(73) Assignee: HL MANDO CORPORATION, Pyeongtaek-si (KR)

(21) Appl. No.: 19/409,205

(22) Filed: Dec. 4, 2025

(30) Foreign Application Priority Data
Feb. 11, 2025 (KR) 10-2025-0017525

(51) Int. Cl. F16D 65/097; F16D 55/00

(52) U.S. Cl. CPC F16D 65/0979; F16D 65/0977; F16D 2055/0041

(57) ABSTRACT

A brake pad liner and a brake assembly comprising the same are disclosed. The brake assembly may include at least one brake pad; a bracket in which the brake pad is slidably mounted; a caliper slidably mounted to the bracket to operate the brake pad; and at least one brake pad liner disposed between the bracket and the brake pad and configured to slidably support the brake pad. The brake pad liner may include a first body disposed such that a side portion of the brake pad is inserted in the first body; and a first elastic arm configured to extend forward from the first body and provide a reaction force against a force applied by the brake pad forward of the first body.

### CROSS-REFERENCE TO RELATED APPLICATION

This application claims priority to and benefit from Korean Patent Application No. 10-2025-0017525, filed on February 11, 2025, the disclosure of which is incorporated herein by reference in its entirety.

### TECHNICAL FIELD

The present disclosure relates to a brake pad liner and a brake assembly comprising the same, and more particularly, to a brake pad liner that guides the movement of a brake pad configured to generate braking force by contacting a disc rotating with a wheel of a vehicle, and to a brake assembly comprising the same.

### DESCRIPTION OF RELATED ART

The brake assembly is mounted to a vehicle and constitutes a brake that operates to reduce the speed of the vehicle or to maintain the vehicle in a stopped state. The brake assembly disposed in a caliper brake includes a brake pad that generates braking force by pressing both side surfaces of a disc rotating with a wheel of the vehicle, a bracket on which the brake pad is installed, a caliper that operates the brake pad, and a brake pad liner disposed between the bracket and the brake pad.

The caliper brake generates braking force by bringing the brake pad into contact with the disc through operation of the caliper. At the moment when the friction material of the brake pad is pressed against the disc, the brake pad moves in the rotational direction of the disc, and components that have been spaced apart collide with each other, thereby generating an impact noise referred to as a "click" noise. Such a phenomenon is known to frequently occur when the brake is operated at low speed while moving forward after the brake has been repeatedly operated during reverse driving.

### BRIEF SUMMARY

An object of the present disclosure is to provide a brake pad liner and a brake assembly including the same, which reduce noise caused by impacts between components occurring when a brake pad of a caliper brake comes into contact with a disc and moves in a rotational direction of the disc.

Another object of the present disclosure is to provide a brake pad liner and a brake assembly including the same, which return the brake pad stably and efficiently when braking is released.

The objects of the present disclosure are not limited to the above-described objects, and other objects that are not mentioned will be able to be clearly understood by those skilled in the art to which the present disclosure pertains from the following description.

According to an aspect of the present disclosure, provided is a brake assembly, including at least one brake pad; a bracket in which the brake pad is slidably mounted; a caliper slidably mounted to the bracket to operate the brake pad; and at least one brake pad liner disposed between the bracket and the brake pad and configured to slidably support the brake pad, wherein the brake pad liner includes a first body configured to receive a side portion of the brake pad; and a first elastic arm configured to extend forward from the first body and provide a reaction force against a force applied by the brake pad forward of the first body.

In the brake assembly according to an aspect of the present disclosure, the first elastic arm may include a first extension protruding from one side of the first body and extending toward a front of the other side of the first body with a change in direction.

In the brake assembly according to an aspect of the present disclosure, the first elastic arm may further include a first additional extension extending from an end of the first extension in a direction toward the other side of the first body.

In the brake assembly according to an aspect of the present disclosure, the first elastic arm may further include a first hook portion extending from an end of the first additional extension toward a front of the other side of the first body, and then extending toward a front of one side of the first body with a change in direction.

In the brake assembly according to an aspect of the present disclosure, the first elastic arm may further include a first tip portion additionally extending from an end of the first hook portion in a direction toward one side of the first body.

In the brake assembly according to an aspect of the present disclosure, the brake pad liner may further include a first return arm configured to extend from the first body and press the brake pad in a direction toward one side of the first body.

In the brake assembly according to an aspect of the present disclosure, the first return arm may be configured to extend from the other side of the first body.

In the brake assembly according to an aspect of the present disclosure, the first elastic arm may be disposed above the first return arm.

In the brake assembly according to an aspect of the present disclosure, the brake pad liner may further include a second body spaced apart from the first body and disposed such that a side portion of the brake pad is inserted in the second body; a bridge connecting the first body and the second body; and a second elastic arm configured to extend forward from the second body and provide a reaction force against a force applied by the brake pad toward a front of the second body.

In the brake assembly according to an aspect of the present disclosure, the second body and the second elastic arm may be symmetrical to the first body and the first elastic arm with respect to the bridge.

In the brake assembly according to an aspect of the present disclosure, the brake pad liner may further include a second return arm configured to press the brake pad in a direction toward one side of the second body, the one side being farther from the first body among both sides of the second body.

According to another aspect of the present disclosure, provided is a brake pad liner, including a first body; and a first elastic arm configured to extend forward from the first body and provide a reaction force against a force applied toward a front of the first body.

In the brake pad liner according to an aspect of the present disclosure, the first elastic arm may include a first extension protruding from one side of the first body and extending toward a front of the other side of the first body with a change in direction.

In the brake pad liner according to an aspect of the present disclosure, the first elastic arm may further include a first additional extension extending from an end of the first extension in a direction toward the other side of the first body.

In the brake pad liner according to an aspect of the present disclosure, the first elastic arm may further include a first hook portion extending from an end of the first additional extension toward a front of the other side of the first body, and then extending toward a front of one side of the first body with a change in direction.

In the brake pad liner according to an aspect of the present disclosure, the first elastic arm may further include a first tip portion additionally extending from an end of the first hook portion in a direction toward one side of the first body.

The brake pad liner according to an aspect of the present disclosure may further include a first return arm configured to extend from the first body and provide a reaction force against a force applied in a direction toward the other side of the first body.

In the brake pad liner according to an aspect of the present disclosure, the first return arm may be configured to extend from the other side of the first body.

In the brake pad liner according to an aspect of the present disclosure, the first elastic arm may be disposed above the first return arm.

The brake pad liner according to an aspect of the present disclosure may further include a second body spaced apart from the other side of the first body; a bridge connecting the first body and the second body; and a second elastic arm configured to extend forward from the second body and provide a reaction force against a force applied toward a front of the second body.

### BRIEF DESCRIPTION OF THE SEVERAL VIEWS OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a brake assembly according to an exemplary embodiment of the present disclosure;

FIG. 2 is a view illustrating a separated state of a caliper of the brake assembly according to an exemplary embodiment of the present disclosure;

FIG. 3 is a perspective view of a brake pad liner according to an exemplary embodiment of the present disclosure, as viewed from one front side of a first body;

FIG. 4 is a perspective view of a brake pad liner according to an exemplary embodiment of the present disclosure, as viewed from one front side of a second body;

FIG. 5 is a rear perspective view of the brake pad liner according to an exemplary embodiment of the present disclosure;

FIG. 6 is a plan view of the brake pad liner according to an exemplary embodiment of the present disclosure;

FIG. 7 is a side view of the brake pad liner according to an exemplary embodiment of the present disclosure;

FIG. 8 is a perspective view of a state in which the brake pad liner is coupled to a bracket and a brake pad is disposed according to an exemplary embodiment of the present disclosure;

FIG. 9 is a view illustrating a state in which the brake pad liner is coupled to a bracket and a brake pad is disposed, as viewed from a side of the brake pad liner according to an exemplary embodiment of the present disclosure;

FIG. 10 is a plan view of a state in which the brake pad liner is coupled to a bracket and a brake pad is disposed according to an exemplary embodiment of the present disclosure; and

FIG. 11 is a view illustrating the operation of an elastic arm of the brake pad liner in the brake assembly according to an exemplary embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

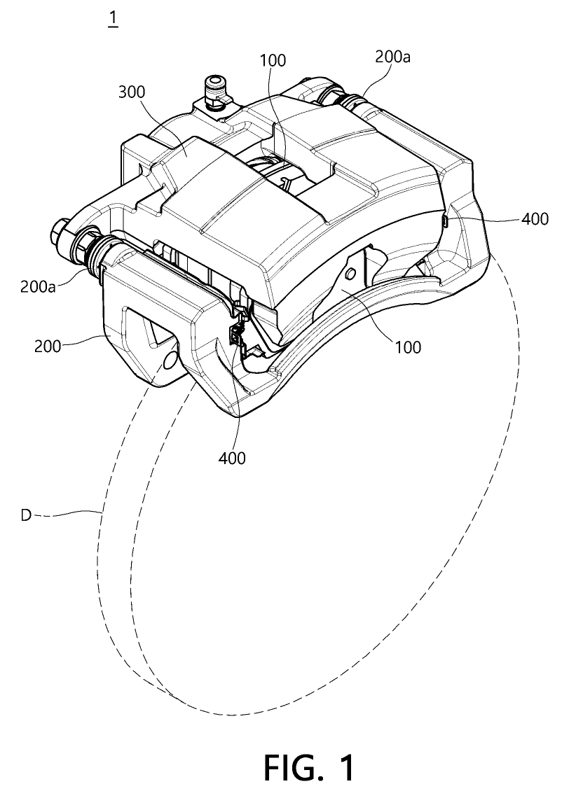

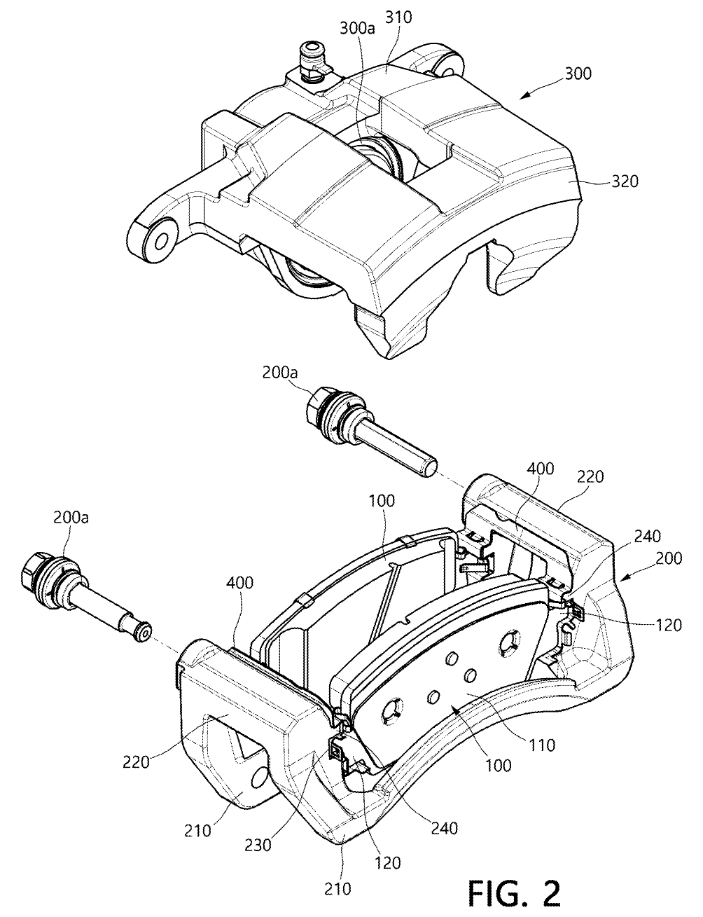

FIG. 1 is a perspective view of a brake assembly according to an exemplary embodiment of the present disclosure. FIG. 2 is a view illustrating a separated state of a caliper of the brake assembly according to an exemplary embodiment of the present disclosure.

A brake assembly 1 according to an exemplary embodiment of the present disclosure is installed in a vehicle and generates braking force by contacting a disc D that rotates with a wheel of the vehicle. The brake assembly 1 may provide braking force for decelerating or stopping the vehicle during driving of the vehicle. In addition, the brake assembly 1 may maintain a parking state by restricting rotation of the disc D when the vehicle is stopped or parked.

Referring to FIGS. 1 and 2, a brake assembly 1 according to an exemplary embodiment of the present disclosure includes a brake pad 100, a bracket 200, a caliper 300, and a brake pad liner 400.

The brake pad 100 is disposed to be contactable with one surface of the disc D. The brake pad 100 may be provided in at least one. The brake assembly 1 according to an exemplary embodiment of the present disclosure includes a pair of brake pads 100, each of which is disposed to be contactable with respective opposite surfaces of the disc D.

When defining the surface of the disc D illustrated in FIG. 1 to be visible as an outer surface of the disc D and the opposite surface as an inner surface of the disc D, one of the pair of brake pads 100 is disposed to be contactable with the outer surface of the disc D, and the other is disposed to be contactable with the inner surface of the disc D. In other words, the pair of brake pads 100 are spaced apart from each other and disposed to face each other so as to be contactable with the outer surface and the inner surface of the disc D, respectively.

Referring to FIG. 2, the brake pad 100 includes a brake pad body 110 in which a friction material configured to generate braking force through friction with the disc D is disposed, and protrusions 120 protruding laterally from both sides of the brake pad body 110.

The bracket 200 supports the brake pad 100. More specifically, the brake pad 100 is slidably installed on the bracket 200. A pair of brake pads 100 are disposed on the bracket 200 so as to advance toward or retract from the outer surface or the inner surface of the disc D.

The bracket 200 may be installed on a knuckle (not shown) of the vehicle so as to be disposed to surround one outer peripheral side of the disc D. More specifically, a portion of the disc D may enter an inner side of the bracket 200 and be disposed in a rotatable state.

Referring to FIG. 2, the bracket 200 includes a bracket body 210 on which the pair of brake pads 100 are installed to be advanceable and retractable with respect to the disc D. In an exemplary embodiment of the present disclosure, a pair of bracket bodies 210 may be spaced apart from each other and disposed to face each other so that the pair of brake pads 100 are respectively disposed therein. The pair of bracket bodies 210 are disposed spaced apart from each other, and the disc D may enter and be disposed in a space therebetween.

Each bracket body 210 is formed to support a lower portion and both sides of the brake pad 100. For example, the bracket body 210 may have a substantially U-shaped configuration.

The pair of bracket bodies 210 may be connected to each other by a bracket bridge 220. More specifically, the bracket bridge 220 connects upper ends of both sides of the pair of bracket bodies 210, and the pair of bracket bridges 220 may be disposed side by side. The pair of bracket bodies 210 and the pair of bracket bridges 220 may be integrally formed.

The bracket 200 may further include bracket grooves 230 into which the protrusions 120 disposed on both sides of each brake pad 100 are fitted, and coupling steps 240 disposed above the bracket grooves 230. More specifically, inner side surfaces of both lateral sides of each bracket body 210 are recessed to form the bracket grooves 230, and the coupling steps 240 may be formed to protrude above the bracket grooves 230 of each bracket body 210.

The grooves 230 and the coupling steps 240 are respectively provided one on each side of each bracket body 210. In other words, the bracket 200 may have four grooves 230 and four coupling steps 240.

The caliper 300 is slidably mounted to the bracket 200. The caliper 300 operates the brake pad 100 while sliding with respect to the bracket 200.

Referring to FIG. 1, the caliper 300 may be mounted to the bracket 200 by a pair of sliding pins 200a that penetrate the caliper 300 at both sides of the caliper 300 and are inserted into the bracket 200.

The pair of sliding pins 200a may be coupled one-to-one with the pair of bracket bridges 220. In this case, each sliding pin 200a may be disposed such that its axial direction is parallel to the moving direction of the brake pad 100. The caliper 300 may advance or retract along the sliding pins 200a.

Referring to FIG. 2, the caliper 300 includes a caliper body 310 and a caliper finger 320.

An actuator 300a is disposed in the caliper body 310. The actuator 300a may operate hydraulically or mechanically. When the brake pad 100 disposed to face the inner surface of the disc D is pressed toward the disc D by the actuator 300a so as to come into contact with the inner surface of the disc D, the caliper body 310 slides along the sliding pins 200a in a direction away from the inner surface of the disc D.

The caliper finger 320 is connected to the caliper body 310 so as to contact the brake pad 100 disposed to face the outer surface of the disc D. When the caliper body 310 slides along the sliding pins 200a in a direction away from the inner surface of the disc D, the caliper finger 320 moves the brake pad 100 disposed to face the outer surface of the disc D toward the outer surface of the disc D.

The brake pad liner 400 is disposed between the bracket 200 and the brake pad 100 to slidably support the brake pad 100. Referring to FIG. 2, the brake pad liner 400 may be fitted into the bracket grooves 230 formed in the bracket body 210.

The brake pad liner 400 may be provided in one or more. In an exemplary embodiment of the present disclosure, the brake pad liner 400 is provided as a pair. That is, the pair of brake pad liners 400 are disposed between the pair of brake pads 100 and the bracket 200.

Each brake pad liner 400 may be disposed to rest on a corresponding one of the pair of bracket bodies 210. More specifically, one brake pad liner 400 may support the same side surfaces of the pair of brake pads 100, respectively, and the other brake pad liner 400 may support the opposite side surfaces of the pair of brake pads 100, respectively.

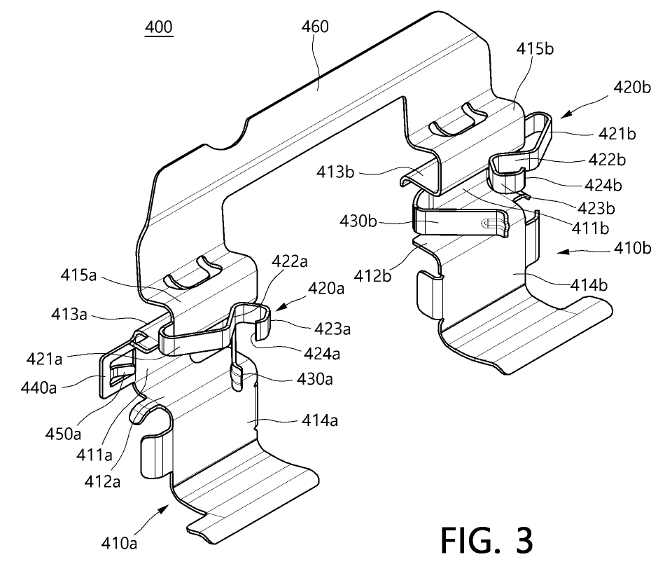

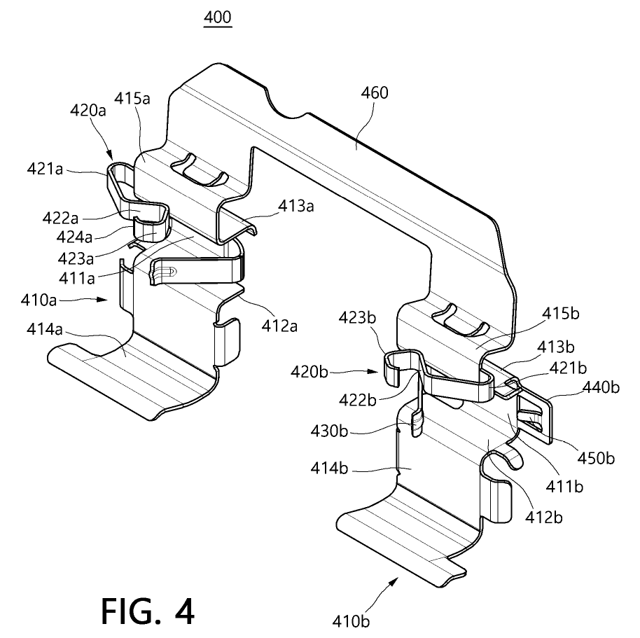

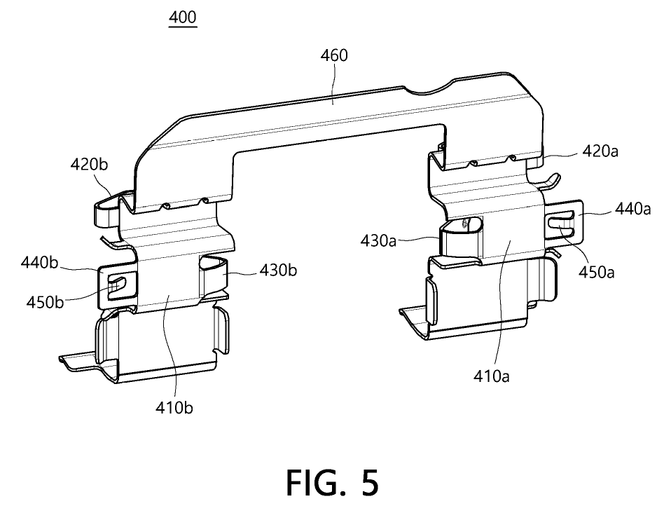

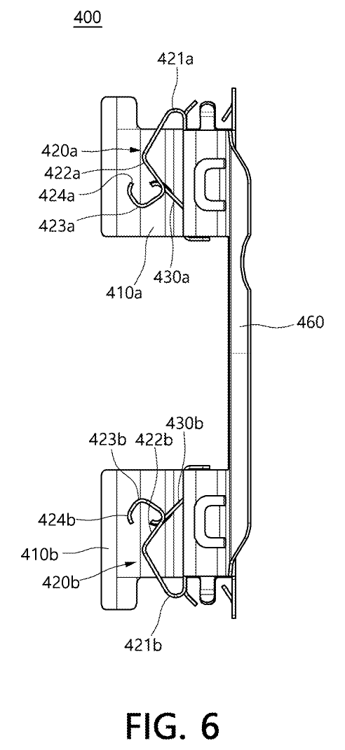

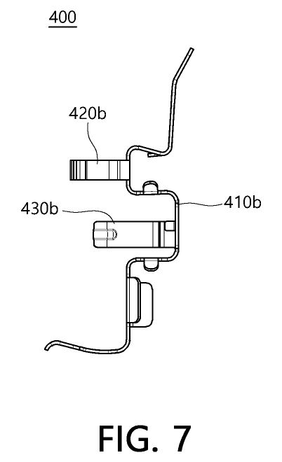

FIG. 3 is a perspective view of a brake pad liner according to an exemplary embodiment of the present disclosure, as viewed from one front side of a first body. FIG. 4 is a perspective view of a brake pad liner according to an exemplary embodiment of the present disclosure, as viewed from one front side of a second body. FIG. 5 is a rear perspective view of the brake pad liner according to an exemplary embodiment of the present disclosure. FIG. 6 is a plan view of the brake pad liner according to an exemplary embodiment of the present disclosure. FIG. 7 is a side view of the brake pad liner according to an exemplary embodiment of the present disclosure.

Referring to FIGS. 3 to 6, the brake pad liner 400 may include a first body 410a and a first elastic arm 420a.

The first body 410a may have a shape into which a side portion of the brake pad 100, that is, the protrusion 120 of the brake pad 100, is insertable. The first body 410a slidably supports one lateral side of the brake pad 100.

The first body 410a includes a first base 411a, a first lower extension 412a protruding forward from a lower end of the first base 411a, and a first upper extension 413a protruding forward from an upper end of the first base 411a. The first base 411a may have a plate shape. In addition, the first lower extension 412a and the first upper extension 413a may be formed by being bent forward from the lower end and the upper end of the first base 411a, respectively.

The first base 411a, the first lower extension 412a, and the first upper extension 413a form a channel having a shape corresponding to the groove 230 of the bracket 200 and are inserted into and disposed in the groove 230.

The protrusion 120 of the brake pad 100 may be inserted into the channel formed by the first base 411a, the first lower extension 412a, and the first upper extension 413a. The brake pad 100 may slide toward the disc D or slide away from the disc D within the channel formed by the first base 411a, the first lower extension 412a, and the first upper extension 413a.

The first body 410a may further include a first lower additional extension 414a additionally extending downward from a protruding end of the first lower extension 412a, and a first upper additional extension 415a additionally extending upward from a protruding end of the first upper extension 413a. The first lower additional extension 414a and the first upper additional extension 415a may include portions bent forward or rearward.

The first lower additional extension 414a and the first upper additional extension 415a may have shapes corresponding to contact portions of the bracket body 210 so that the brake pad liner 400 can be stably fixed to the bracket body 210. For example, the first upper extension 413a and the first upper additional extension 415a may form a groove into which the coupling step 240 of the bracket 200 is inserted.

The first elastic arm 420a extends forward from the first body 410a to provide a reaction force against a force applied toward the front of the first body 410a. In the brake assembly 1, the first elastic arm 420a provides a reaction force against a force applied by the brake pad 100 toward the front of the first body 410a. Through this, the first elastic arm 420a suppresses noise caused by impacts between components when the brake pad 100 moves in the rotational direction of the disc D upon contacting the disc D.

Referring to FIGS. 3, 4, and 6,the first elastic arm 420a may include a first extension 421a, a first additional extension 422a, and a first hook portion 423a.

The first extension 421a protrudes from one side of the first body 410a and extends with its direction switched toward the front of the other side of the first body 410a. The first extension 421a may protrude from one side of the first upper additional extension 415a. The first extension 421a may extend protruding from one side of the first body 410a and then extend toward the front of the other side of the first body 410a with its direction changed in a U-shape.

The first additional extension 422a extends from an end of the first extension 421a in a direction toward the other side of the first body 410a. The first additional extension 422a additionally extends with the extending direction of the first extension 421a changed toward the other side of the first body 410a.

The first hook portion 423a extends from an end of the first additional extension 422a toward the front of the other side of the first body 410a, and then extends with its direction changed toward the front of one side of the first body 410a. The first hook portion 423a may be formed in a U-shape or a V-shape.

In addition, the first elastic arm 420a may further include a first tip portion 424a that additionally extends from an end of the first hook portion 423a in a direction toward one side of the first body 410a.

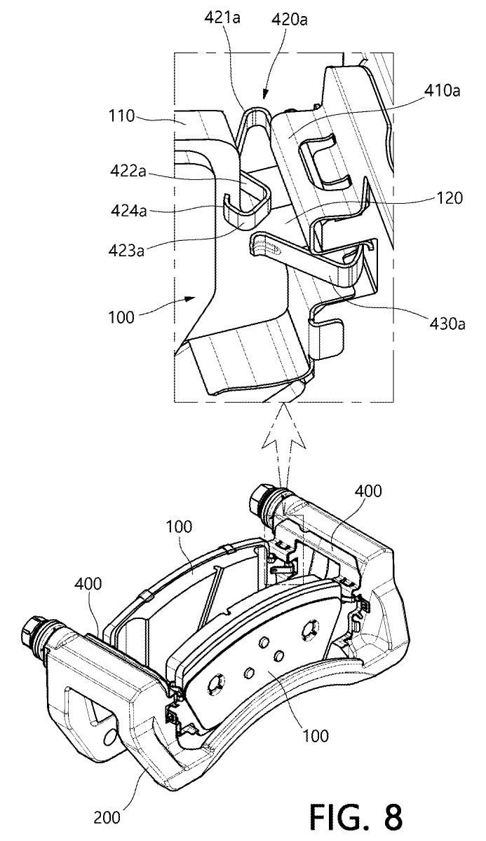

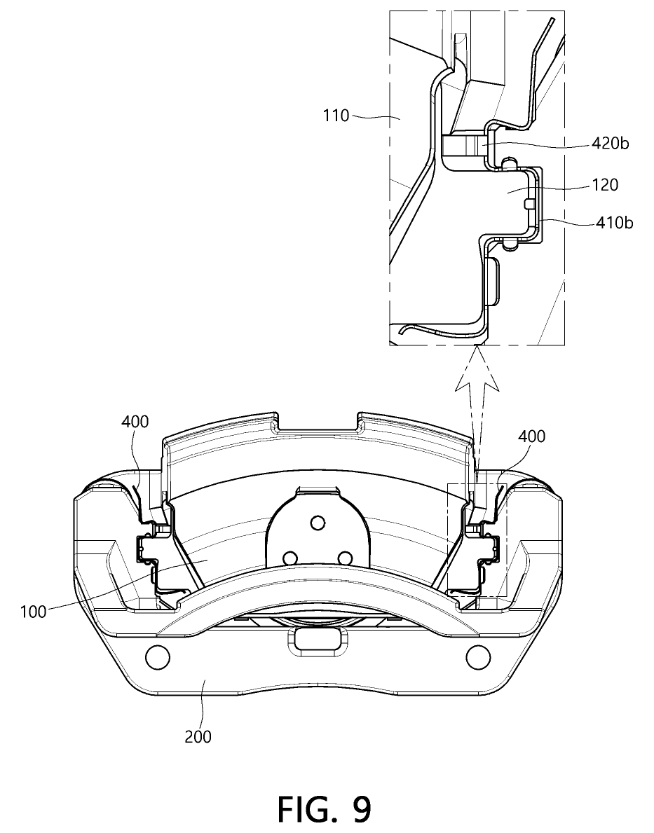

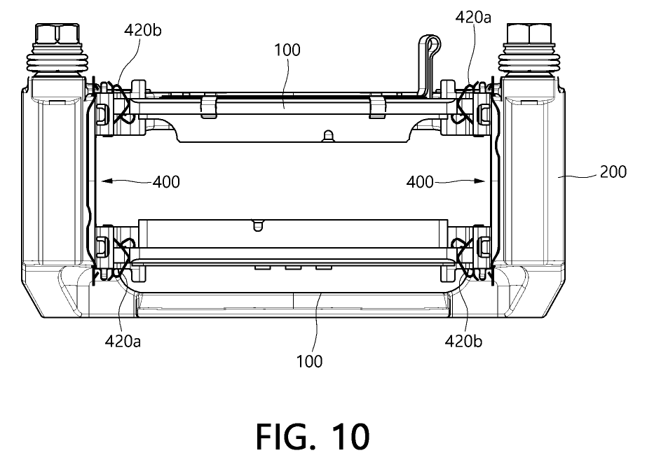

FIG. 8 is a perspective view of a state in which the brake pad liner is coupled to a bracket and a brake pad is disposed according to an exemplary embodiment of the present disclosure. FIG. 9 is a view illustrating a state in which the brake pad liner is coupled to a bracket and a brake pad is disposed, as viewed from a side of the brake pad liner according to an exemplary embodiment of the present disclosure. FIG. 10 is a plan view of a state in which the brake pad liner is coupled to a bracket and a pair of brake pads are disposed according to an exemplary embodiment of the present disclosure.

Referring to FIGS. 8 to 10, the first elastic arm 420a supports a side surface of the brake pad 100. More specifically, the first elastic arm 420a presses the brake pad 100 in a direction perpendicular to an operating direction of the brake pad 100 during braking.

The first extension 421a and the first additional extension 422a form a projecting portion protruding forward from the first body 410a, and the projecting portion formed by the first extension 421a and the first additional extension 422a may contact a side surface of the brake pad 100 to provide a pressing force to the brake pad 100.

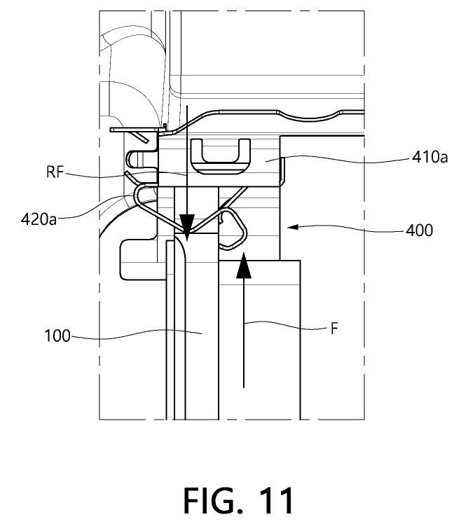

FIG. 11 is a view illustrating the operation of an elastic arm of the brake pad liner in the brake assembly according to an exemplary embodiment of the present disclosure.

Referring to FIG. 11, when the brake pad 100, while contacting the rotating disc D, receives a force F in the rotational direction of the disc D and moves toward the front of the first body 410a of the brake pad liner 400, the first elastic arm 420a provides a reaction force RF against the force F. Accordingly, collision of the brake pad 100 with the brake pad liner 400 is prevented, and noise caused by impacts between components can be avoided.

The first hook portion 423a contacts one surface of the brake pad 100 facing the disc D. Through the first hook portion 423a, the first elastic arm 420a may also press the brake pad 100 in a direction away from the disc D. In other words, the first elastic arm 420a may provide a return force that assists the brake pad 100 in returning when braking is released through the first hook portion 423a. Meanwhile, the first tip portion 424a forms a point of action of force so that the first elastic arm 420a can stably provide the return force to one surface of the brake pad 100.

Referring to FIGS. 3 to 6 and FIG. 8, the brake pad liner 400 may further include a first return arm 430a extending from the first body 410a to provide a reaction force against a force applied in a direction toward the other side of the first body 410a. The first return arm 430a extends from the first body 410a and may press the brake pad 100 in a direction toward one side of the first body 410a.

When the side of the first body 410a from which the first elastic arm 420a protrudes is defined as one side of the first body 410a, the first return arm 430a may extend from the other side of the first body 410a. More specifically, the first return arm 430a may protrude from the first base 411a of the first body 410a and extend with its direction changed toward the front side of the first body 410a.

The first return arm 430a presses the brake pad 100 in a direction away from the disc D. That is, the first return arm 430a provides a return force to the brake pad 100 when braking is released.

The first return arm 430a may be disposed below the first elastic arm 420a. In other words, the first elastic arm 420a may be disposed above the first return arm 430a. Through such an arrangement, the first elastic arm 420a and the first return arm 430a respectively provide return forces to the brake pad 100, thereby enhancing the overall return force while preventing interference between them.

Referring to FIGS. 3 and 5, the brake pad liner 400 may further include a first handle 440a and a first stopper 450a.

The first handle 440a may protrude laterally from one side of the first body 410a. The first handle 440a may be gripped by an operator when the brake pad liner 400 is installed in the bracket 200. The first handle440a may have a ring shape.

The first stopper 450a protrudes in front of the first body 410a. The first stopper 450a may protrude forward from the first handle 440a. The first stopper450a prevents the brake pad 100 from disengaging from the bracket 200. When the brake pad 100 moves beyond its operating range and away from the disc D, the first stopper 450a presses the protrusion 120 of the brake pad 100 toward the disc D.

Referring to FIGS. 3 to 7, the brake pad liner 400 may further include a second body 410b, a bridge 460, and a second elastic arm 420b.

The second body 410b is disposed spaced apart from the other side of the first body 410a. The second body 410b is disposed such that a side portion of the brake pad 100 is inserted therein. The second body 410b slidably supports one side of the brake pad 100.

The bridge 460 connects the first body 410a and the second body 410b. The bridge 460 may be disposed to connect an upper end of the first body 410a and an upper end of the second body 410b. The second body 410b and the second elastic arm 420b may be symmetrical with the first body 410a and the first elastic arm 420a with reference to the bridge 460.

The second body 410b includes a second base 411b, a second lower extension 412b protruding forward from a lower end of the second base 411b, and a second upper extension 413b protruding forward from an upper end of the second base 411b. The second base 411b may have a plate shape. In addition, the second lower extension 412b and the second upper extension 413b may be formed by being bent forward from the lower end and the upper end of the second base 411b, respectively.

The second base 411b, the second lower extension 412b, and the second upper extension 413b form a channel having a shape corresponding to the groove 230 of the bracket 200 and are inserted into and disposed in the groove 230.

The protrusion 120 of the brake pad 100 may be inserted into the channel formed by the second base 411b, the second lower extension 412b, and the second upper extension 413b. The brake pad 100 may slide toward the disc D or slide away from the disc D within the channel formed by the second base 411b, the second lower extension 412b, and the second upper extension 413b.

The second body 410b may further include a second lower additional extension 414b additionally extending downward from a protruding end of the second lower extension 412b, and a second upper additional extension 415b additionally extending upward from a protruding end of the second upper extension 413b. The second lower additional extension 414b and the second upper additional extension 415b may include portions bent forward or rearward, allowing the brake pad liner 400 to be stably fixed to the bracket body 210.

In an exemplary embodiment of the present disclosure, the second upper extension 413b and the second upper additional extension 415b may form a groove into which the coupling step 240 of the bracket 200 is inserted.

The second elastic arm 420b extends forward from the second body 410b to provide a reaction force against a force applied by the brake pad 100 toward the front of the second body 410b. The second elastic arm 420b suppresses noise caused by impacts between components when the brake pad 100 moves in the rotational direction of the disk D upon contacting the disk D.

The second elastic arm 420b may include a second extension 421b, a second additional extension 422b, and a second hook portion 423b.

The second extension 421b protrudes from one side of the second body 410b and then extends with its direction switched toward the front of the other side of the second body 410b. Here, the one side of the second body 410b may be a side that is distant from and not adjacent to the first body 410a among both sides of the second body 410b. The second extension 421b may protrude from one side of the second upper additional extension 415b. The second extension 421b may extend protruding from one side of the second body 410b and then extend toward the front of the other side of the second body 410b with its direction changed in a U-shape.

The second additional extension 422b extends from an end of the second extension 421b in a direction toward the other side of the second body 410b. The second additional extension 422b additionally extends with the extending direction of the second extension 421b changed toward the other side of the second body 410b.

The second hook portion 423b extends from an end of the second additional extension 422b toward the front of the other side of the second body 410b, and then extends with its direction changed toward the front of one side of the second body 410b. The second hook portion 423b may be formed in a U-shape or a V-shape.

In addition, the second elastic arm 420b may further include a second tip portion 424b that additionally extends from an end of the second hook portion 423b in a direction toward one side of the second body 410b.

The function and operation of the second elastic arm 420b are the same as those described in relation to the first elastic arm 420a. Therefore, a detailed description related to the function and operation of the second elastic arm 420b will be omitted.

Referring to FIGS. 3 to 8, the brake pad liner 400 may further include a second return arm 430b that extends from the second body 410b and presses the brake pad 100 in a direction toward one side of the second body 410b.

The second return arm 430b may extend from the other side of the second body410b. The second return arm 430b provides a return force that presses the brake pad 100 in a direction away from the disc D.

Referring to FIGS. 4 and 5, the brake pad liner 400 may further include a second handle 440b and a second stopper 450b.

The second handle 440b may protrude laterally from one side of the second body 410b. The second handle 440b may be gripped by an operator when the brake pad liner 400 is installed in the bracket 200. The second handle 440b may have a ring shape.

The second stopper 450b protrudes in front of the second body 410b. The second stopper 450b may protrude forward from the second handle 440b. The second stopper450b prevents the brake pad 100 from disengaging from the bracket 200.

According to the above configuration, the brake pad liner and the brake assembly including the same according to the present disclosure reduce noise caused by impacts between components by suppressing the impacts between components through at least one elastic arm that provides a reaction force against a force applied to the brake pad liner when the brake pad moves in the rotational direction of the disc while being in contact with the disc.

In addition, the brake pad liner and the brake assembly including the same according to the present disclosure stably and efficiently return the brake pad upon release of braking through a combination of at least one elastic arm and at least one return arm.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

1. A brake assembly, comprising:
at least one brake pad;
a bracket in which the brake pad is slidably mounted;
a caliper slidably mounted to the bracket to operate the brake pad; and
at least one brake pad liner disposed between the bracket and the brake pad and configured to slidably support the brake pad,
wherein the brake pad liner comprises:
a first body configured to receive a side portion of the brake pad; and
a first elastic arm configured to extend forward from the first body and provide a reaction force against a force applied by the brake pad forward of the first body.

2. The brake assembly of claim 1, wherein the first elastic arm comprises a first extension protruding from one side of the first body and extending toward a front of the other side of the first body with a change in direction.

3. The brake assembly of claim 2, wherein the first elastic arm further comprises a first additional extension extending from an end of the first extension in a direction toward the other side of the first body.

4. The brake assembly of claim 3, wherein the first elastic arm further comprises a first hook portion extending from an end of the first additional extension toward a front of the other side of the first body, and then extending toward a front of one side of the first body with a change in direction.

5. The brake assembly of claim 4, wherein the first elastic arm further comprises a first tip portion additionally extending from an end of the first hook portion in a direction toward one side of the first body.

6. The brake assembly of claim 1, wherein the brake pad liner further comprises a first return arm configured to extend from the first body and press the brake pad in a direction toward one side of the first body.

7. The brake assembly of claim 6, wherein the first return arm is configured to extend from the other side of the first body.

8. The brake assembly of claim 6, wherein the first elastic arm is disposed above the first return arm.

9. The brake assembly of claim 1,
wherein the brake pad liner further comprises:
a second body spaced apart from the first body and disposed such that a side portion of the brake pad is inserted in the second body;
a bridge connecting the first body and the second body; and
a second elastic arm configured to extend forward from the second body and provide a reaction force against a force applied by the brake pad toward a front of the second body.

10. The brake assembly of claim 9, wherein the second body and the second elastic arm are symmetrical to the first body and the first elastic arm with respect to the bridge.

11. The brake assembly of claim 9, wherein the brake pad liner further comprises a second return arm configured to press the brake pad in a direction toward one side of the second body, the one side being farther from the first body among both sides of the second body.

12. A brake pad liner, comprising:
a first body; and
a first elastic arm configured to extend forward from the first body and provide a reaction force against a force applied toward a front of the first body.

13. The brake pad liner of claim 12, wherein the first elastic arm comprises a first extension protruding from one side of the first body and extending toward a front of the other side of the first body with a change in direction.

14. The brake pad liner of claim 13, wherein the first elastic arm further comprises a first additional extension extending from an end of the first extension in a direction toward the other side of the first body.

15. The brake pad liner of claim 14, wherein the first elastic arm further comprises a first hook portion extending from an end of the first additional extension toward a front of the other side of the first body, and then extending toward a front of one side of the first body with a change in direction.

16. The brake pad liner of claim 15, wherein the first elastic arm further comprises a first tip portion additionally extending from an end of the first hook portion in a direction toward one side of the first body.

17. The brake pad liner of claim 12, further comprising a first return arm configured to extend from the first body and provide a reaction force against a force applied in a direction toward the other side of the first body.

18. The brake pad liner of claim 17, wherein the first return arm is configured to extend from the other side of the first body.

19. The brake pad liner of claim 17, wherein the first elastic arm is disposed above the first return arm.

20. The brake pad liner of claim 12, further comprising:
a second body spaced apart from the other side of the first body;
a bridge connecting the first body and the second body; and
a second elastic arm configured to extend forward from the second body and provide a reaction force against a force applied toward a front of the second body.
